(19) United States
(12) Patent Application Publication
(10) Pub. No.: US 2021/0255034 A1
(43) Pub. Date: Aug. 19, 2021

(54) SENSOR UNIT AND MOBILE OBJECT

(71) Applicant: SZ DJI TECHNOLOGY CO., LTD., Shenzhen (CN)

(72) Inventors: Gou NAGAYA, Shenzhen (CN); Tatsuya NAKATSUJI, Shenzhen (CN)

(73) Assignee: SZ DJI TECHNOLOGY CO., LTD., Shenzhen (CN)

(21) Appl. No.: 17/306,949

(22) Filed: May 4, 2021

Related U.S. Application Data
(63) Continuation of application No. PCT/CN2020/092969, filed on May 28, 2020.

(30) Foreign Application Priority Data
Jun. 4, 2019 (JP) 2019-104827

(51) Int. Cl. G01J 1/42; G02B 5/02; G02B 6/42; G01J 1/02; G01S 19/43; B64D 47/00; H01Q 7/00; H01Q 1/28

(52) U.S. Cl. CPC G01J 1/42; G02B 5/0263; G02B 6/4298; H01Q 1/28; G01S 19/43; B64D 47/00; H01Q 7/00; G01J 1/0271

(57) ABSTRACT

This disclosure is related to a sensor and a mobile object. The mobile object may include a housing having a light-transmitting portion; a light receiving element inside the housing; and a light guide member inside the housing. The light guide member may be configured to guide light transmitted through the light-transmitting portion to the light receiving element.

### CROSS-REFERENCE TO RELATED APPLICATIONS

The present application is a continuation of International Application No. PCT/CN2020/092969, filed May 28, 2020, which claims priority to Japanese Patent Application No. JP2019-104827, filed Jun. 4, 2019, the entire contents of each being incorporated herein by reference in its entirety.

### TECHNICAL FIELD

The present disclosure relates to a sensor unit and a mobile object.

### BACKGROUND

US patent publication No. 2017/03566799 discloses an unmanned aerial vehicle (UAV) having a multi-band sensor and an illuminance sensor.

### SUMMARY

Some embodiments of the present disclosure are intended to assemble an illuminance sensor in a limited space without reducing its measurement accuracy.

One embodiment of the present disclosure discloses a mobile object. The mobile object may include a housing having a light-transmitting portion; a light receiving element inside the housing; and a light guide member inside the housing. The light guide member may be configured to guide light transmitted through the light-transmitting portion to the light receiving element.

One embodiment of the present disclosure discloses a sensor unit. The sensor unit may include a housing with a light-transmitting portion; a light receiving element inside the housing; a light guide member inside the housing; and an antenna inside the housing. The light guide member may be configured to guide light transmitted through the light-transmitting portion to the light receiving element, and the antenna may be configured to surround the light guide member.

One embodiment of the present disclosure discloses a sensor unit. The sensor unit may include a housing comprising a first diffusion plate configured to diffuse and transmit light from outside the housing; a light receiving element inside the housing; a light guide member inside the housing; and a second diffusion plate between the light guide member and the light receiving element. The light guide member may be configured to guide the light transmitted through the first diffusion plate to the light receiving element and the second diffusion plate may be configured to diffuse light from the light guide member.

According to one aspect of this disclosure, it is feasible to assemble light receiving elements of the illuminance sensor in a limited space without reducing the measurement precision and accuracy. It should be noted that the above summary does not include all necessary features required for the disclosure. Furthermore, sub-combinations of these features may also constitute the disclosure.

### BRIEF DESCRIPTION OF THE DRAWINGS

FIG. 1 is a diagram of appearance of an unmanned aerial vehicle (UAV) and a remote operation device according to one embodiment of the present disclosure;

FIG. 2 is a diagram of appearance of an imaging system mounted on an UAV according to one embodiment of the present disclosure;

FIG. 3 is a diagram of appearance of an imaging system mounted on an UAV according to one embodiment of the present disclosure;

FIG. 4 is a diagram of functional blocks of an UAV according to one embodiment of the present disclosure;

FIG. 5 is a perspective view of appearance of a sensor unit according to one embodiment of the present disclosure;

FIG. 6 is an exploded perspective view of a sensor unit according to one embodiment of the present disclosure;

FIG. 7 is a cross-sectional view of a sensor unit according to one embodiment of the present disclosure;

FIG. 8 is a partial enlarged view of a cross-section of a sensor unit according to one embodiment of the present disclosure;

FIG. 9 is a schematic diagram of an incident angle according to one embodiment of the present disclosure;

FIG. 10A shows relationship between illuminance measured by an illuminance sensor and wavelength of light when an incident angle is 0 degree according to one embodiment of the present disclosure;

FIG. 10B shows relationship between illuminance measured by an illuminance sensor and wavelength of light when an incident angle is greater than 0 degree according to one embodiment of the present disclosure;

FIG. 11 is a chart showing relationship between transmittance of a diffusion plate and wavelength of a light according to one embodiment of the present disclosure;

FIG. 12 is a chart showing relationship between transmittance of a diffusion plate and wavelength of a light according to one embodiment of the present disclosure;

FIG. 13 is a table showing different modes of combination of a first diffusion plate and a second diffusion plate according to one embodiment of the present disclosure;

FIG. 14 is a graph showing deviation amplitudes (%) of the diffusion plates of the combination modes in FIG. 13;

FIG. 15 is a table showing different modes of combination of a first diffusion plate and a second diffusion plate according to one embodiment of the present disclosure;

FIG. 16 is a graph showing deviation amplitudes (%) of diffusion plates of the combination modes in FIG. 15.

### DETAILED DESCRIPTION

Herein, the present disclosure is illuminated through embodiments, but the following embodiments do not limit the disclosure related to the claims. Additionally, not all exemplar embodiments and features described in this disclosure are essential technical solutions for the disclosure. For those of ordinary skill in the art, it will be apparent to modify or make variations to the following described embodiments. Based on the description of claims, those modifications and variations are within the scope of the disclosure.

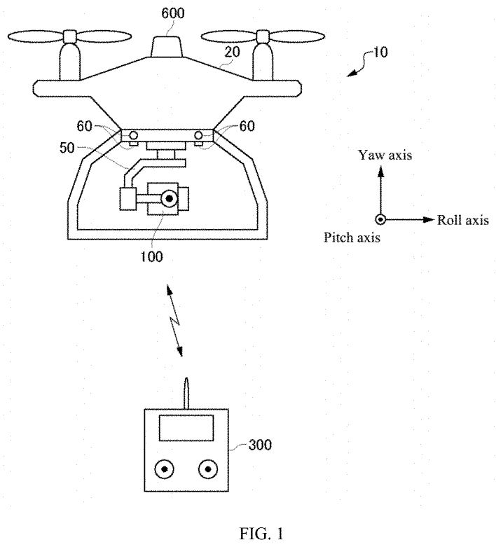

FIG. 1 shows a diagram of appearance of an UAV 10 and a remote operation device 300 according to one embodiment of the present disclosure. The UAV 10 may include a UAV main body 20, a universal joint 50, a plurality of imaging devices 60, an imaging system 100, and a sensor unit 600. The UAV 10 is just an example of a mobile object. A mobile object may refer to a flying object moving in the air, a vehicle moving on the ground, and a vessel moving in the water. Similarly, the flying object moving in the air may include not only UAVs, but also other aircrafts, airships, and helicopters, etc.

The main body 20 of UAV may include a plurality of rotors. The plurality of rotors may be an example of a propulsion unit 40. The main body 20 of UAV may propel the UAV 10 to fly by controlling rotation of the rotors. In one embodiment, the main body 20 of UAV may employ four rotors to drive the UAV 10. The number of rotors is not limited, and does not have to be four. In another embodiment, UAV 10 may also be a fixed-wing aircraft without rotors.

The sensor unit 600 may include an illuminance sensor 500 and a real-time kinematic (RTK) 80. The imaging system 100 may be a multispectral camera for imaging that captures objects within a desired imaging range of each of a plurality of wavelength bands. The universal joint 50 may rotatably support the imaging system 100. The universal joint 50 is an example of a supporting unit. In one embodiment, the universal joint 50 may utilize an actuator to rotatably support the imaging system 100 around a pitch axis. The universal joint 50 may further utilize the actuator to rotatably support the imaging system 100 around a roll axis or a yaw axis respectively. The universal joint 50 may change the posture of the imaging system 100 by rotating the imaging system 100 around at least one of the yaw axis, the pitch axis, and the roll axis.

The plurality of imaging devices 60 may be sensing cameras that photograph the surrounding of the UAV 10 in order to control the flight of the UAV 10. Two imaging devices 60 may be installed on the nose of the UAV 10, that is, on the front side, and two imaging devices 60 may be installed on the bottom surface of the UAV 10. The two imaging devices 60 on the front side may be paired to function as a so-called stereo camera, and the other two imaging devices 60 on the bottom side may also be paired to function as a stereo camera. The imaging device 60 may detect existence of an object within its imaging range and measure the distance to the object. Herein, the imaging device 60 is just an example of a measuring device that may measure objects in the imaging direction of the imaging system 100. The measuring device may be other sensors such as an infrared sensor or an ultrasonic sensor that measures an object existing in the imaging direction of the imaging system 100. The three-dimensional spatial data around the UAV 10 may be generated based on the images taken by the imaging devices 60. The number of imaging devices 60 included in the UAV 10 is not limited to four. The UAV 10 may include at least one imaging device 60. The UAV 10 may include at least one imaging device 60 on the nose, tail, side, bottom, and top surfaces of the UAV 10, respectively. The viewing angle that may be set in the imaging device 60 may be larger than the viewing angle that may be set in the imaging system 100. The imaging device 60 may also have a single focus lens or a fisheye lens.

The remote operation device 300 may communicate and remotely operate the UAV 10. The remote operation device 300 may wirelessly communicate with the UAV 10. The remote operation device 300 may transmit to the UAV 10 instruction information including various instructions related to the movement of the UAV 10 such as ascending, descending, accelerating, decelerating, forwarding, retreating, and rotating. In one embodiment, the instruction information may include, for example, instruction information for raising the altitude of the UAV 10 or may indicate the altitude at which the UAV 10 should be located. The UAV may move to the altitude indicated by the instruction information received from the remote operation device 300. The instruction information may include an ascending instruction. The UAV 10 may ascend during the period of receiving the ascending instruction. When the UAV 10 reaches the upper altitude limit, even if the ascending instruction is received, the ascent of UAV 10 may be limited.

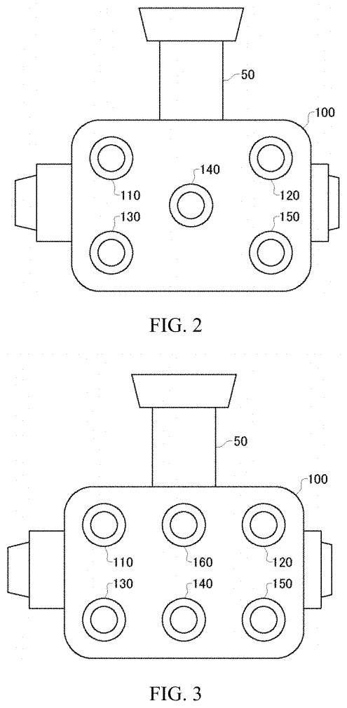

FIG. 2 is a diagram showing appearance of an imaging system 100 mounted on an UAV 10 according to one embodiment of the present disclosure. The imaging system 100 may be a multispectral camera that respectively captures image data in each of a plurality of preset wavelength bands. The imaging system 100 may include an R imaging device 110, an G imaging device 120, an B imaging device 130, an RE imaging device 140, and an NIR imaging device 150. The imaging system 100 may record each image data captured by the R imaging device 110, the G imaging device 120, the B imaging device 130, the RE imaging device 140, and the NIR imaging device 150 respectively as multispectral images. For example, the multispectral images may be used to predict the health and vitality of crops.

The multispectral images may be used to calculate the normalized difference vegetation index (NDVI). NDVI is represented by the following formula 1.

$$NDVI = \frac{IR - R}{IR + R}$$

IR represents reflectance of light of the near infrared region, and R represents reflectance of red light in the visible light region.

The R imaging device 110 may have a filter that transmits light in the red region, and outputs an image signal of the red region, that is, an R image signal. For example, the band of the red region is from 620 nm to 750 nm. The wavelength band of the red region may be a specific band within the red region. For example, it may be 663 nm to 673 nm.

The G imaging device 120 may have a filter that transmits light in the green region, and outputs an image signal of the green region, that is, a G image signal. For example, the band of the green region is 500 nm to 570 nm. The wavelength band of the green region may be a specific wavelength band within the green region. For example, it may be 550 nm to 570 nm.

The B imaging device 130 may have a filter that transmits light in the blue region, and outputs an image signal of the blue region, that is, a B image signal. For example, the band of the blue region is 450 nm to 500 nm. The wavelength band of the blue region may be a specific band within the blue region. For example, it may be 465 nm to 485 nm.

The RE imaging device 140 may have a filter that transmits light in the red edge region, and outputs an image signal of the red edge region, that is, an RE image signal. For example, the band of the red edge region may be 705 nm to 745 nm. The wavelength band of the red edge region may be 712 nm to 722 nm.

The NIR imaging device 150 may have a filter that transmits light in the near-infrared region, and outputs an image signal of the near-infrared region, that is, an NIR image signal. For example, the band of the near infrared region may be 800 nm to 2500 nm. The wavelength band of the near infrared region may be 800 nm to 900 nm.

FIG. 3 is another diagram showing the appearance of the imaging system 100 mounted on the UAV 10 according to one embodiment of the present disclosure. In addition to the G imaging device 120, the B imaging device 130, the RE imaging device 140, and the NIR imaging device 150, the imaging system 100 may also include an RGB imaging device 160, which is different from the imaging system 100 shown in FIG. 2. The RGB imaging device 160 may be similar to an ordinary camera, including an optical system and an image sensor. The image sensor may include a filter that transmits light in the red region, a filter that transmits light in the green region, and a filter that transmits light in the blue region, which are arranged in a Bayer array. The RGB imaging device 160 may output RGB images. For example, the band of the red region may be 620 nm to 750 nm. For example, the band of the green region may be 500 nm to 570 nm. For example, the band of the blue region may be 450 nm to 500 nm.

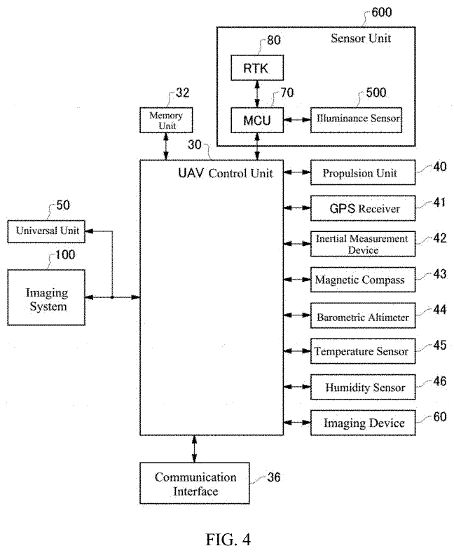

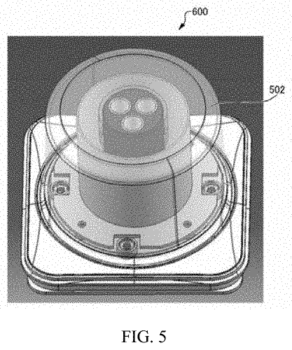

FIG. 4 is a diagram of functional blocks of the UAV 10 according to one embodiment of the present disclosure. The UAV 10 may include an UAV control unit 30, a memory 32, a communication interface 36, a propulsion unit 40, a GPS receiver 41, an inertial measurement unit (IMU) 42, a magnetic compass 43, a barometric altimeter 44, a temperature sensor 45, a humidity sensor 46, an universal joint 50, an imaging device 60 and an imaging system 100.

The communication interface 36 may communicate with the remote operation device 300 and other communication devices. The communication interface 36 may receive various instruction information including various instructions to the UAV control unit 30 from the remote operation device 300. The memory 32 may store programs for the control unit 30 to control the propulsion unit 40, the GPS receiver 41, the inertial measurement unit (IMU) 42, the magnetic compass 43, the barometric altimeter 44, the temperature sensor 45, the humidity sensor 46, the universal joint 50, the imaging device 60, and the imaging system 100. The memory 32 may be a computer-readable recording medium and include at least one of flash memory such as SRAM, DRAM, EPROM, EEPROM, and USB memory. The memory 32 may be provided inside the UAV main body 20, and it may be configured to be detachable from the UAV main body 20.

The control unit 30 may control the flying and imaging of the UAV 10 in accordance with the program being stored in the memory. The control unit 30 may include microprocessors (e.g., CPU or MPU) or processing circuitry, and microcontrollers (e.g., MCU). The control unit 30 manipulates the flight and imaging of the UAV 10 in response to instructions received from the remote operation device 300 via the communication interface 36. The propulsion unit 40 may propel the UAV 10. The propulsion unit 40 may include a plurality of rotors and a plurality of driving motors which rotate the plurality of rotors. The propulsion unit 40 rotates a plurality of rotors via a plurality of driving motors in accordance with an instruction from the UAV control unit 30, thereby enabling the UAV 10 to fly.

The GPS receiver 41 may receive signals representing time transmitted from a plurality of GPS satellites. The GPS receiver 41 may calculate the position (latitude and longitude) of the GPS receiver 41, that is, the position (latitude and longitude) of the UAV 10 based on the received multiple signals. The inertial measurement unit (IMU) 42 may detect the posture of UAV 10, which includes acceleration of the UAV 10 in the direction of three axes, that is, front and rear, left and right, and up and down, and angular velocities in the direction of three axes, that is, the pitch axis, the roll axis, and the yaw axis. The magnetic compass 43 may detect the direction of the nose of UAV 10. The barometric altimeter 44 may detect the flying altitude of the UAV 10 by measuring surrounding air pressure and converting it into an altitude. The temperature sensor 45 may detect the temperature around the UAV 10. The humidity sensor 46 may detect the humidity around the UAV 10.

UAV 10 may include a sensor unit 600. The sensor unit 600 may include a MCU 70, a RTK 80, and an illuminance sensor 500. The MCU 70 may be a control circuitry for RTK 80 and the illuminance sensor 500. The RTK 80 may be a real-time GPS. The RTK 80 may locate the UAV 10 through RTK positioning based on the location information of the base station set in a predetermined location. The illuminance sensor 500 may measure illuminance of the surrounding environment.

The imaging system 100 may implement the imaging control based on the illuminance measured by the illuminance sensor 500. In addition, the imaging system 100 may perform exposure control of each color based on the illuminance of each color measured by the illuminance sensor 500. The imaging system 100 may perform exposure control of the R imaging device 110, the G imaging device 120, the B imaging device 130, the RE imaging device 140, and the NIR imaging device 150 based on the illuminance of each color measured by the illuminance sensor 500.

In one embodiment, in order for the illuminance sensor 500 to measure the illuminance of the surrounding environment with high accuracy, it is preferable that there is no obstacle around the illuminance sensor 500. Optionally, the illuminance sensor 500 is arranged on the top of the UAV 10. The top is the upper part of the UAV 10 housing. The upper part of the UAV 10 housing is a part located on the upper side in the vertical direction when the UAV 10 is hovering. The top is the part opposite to the cavity of the UAV 10 housing when the UAV 10 is hovering. The top is the part on the opposite side of the bottom of the housing facing the ground when the UAV 10 is in the landing state.

In one embodiment, in order for the RTK 80 to receive signals from base stations, satellites, etc., it is preferable that there are no obstacles around the RTK 80. Therefore, RTK 80 is also optionally arranged on the top of UAV 10. However, the space at the top of UAV 10 is limited. Therefore, in one embodiment, the illuminance sensor 500 and the RTK 80 are arranged on the top of the UAV 10 in such a way that the illuminance sensor 500 and the RTK 80 do not interfere with each other.

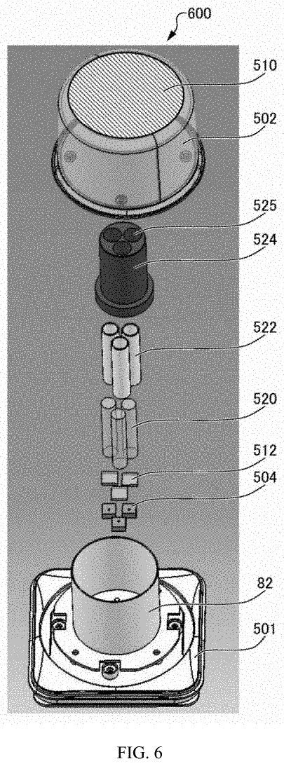

FIG. 5 is an external perspective view of a sensor unit 600 including an illuminance sensor 500 and an RTK 80 according to one embodiment of the present disclosure. In FIG. 5, the housing 502 of the sensor unit 600 is shown in a translucent manner to visualize the inside. FIG. 6 shows an exploded perspective view of the sensor unit 600.

The sensor unit 600 may include a first diffusion plate 510, a housing 502, a cylinder 524, a plurality of rod covers 522, a plurality of light guide members 520, a plurality of second diffusion plates 512, a plurality of light receiving elements 504, an antenna 82, and a base 501. The cylinder 524, the rod covers 522, the second diffusion plates 512, the light receiving elements 504, and the antenna 82 are assembled inside the housing 502. In this embodiment, the housing of the UAV main body 20 of the UAV 10 and the housing of the sensor unit 600 are illuminated in separate configuration. However, the housings of the main body 20 of UAV 10 and the senor unit 600 may be formed integrally. The sensor unit 600 may be built inside the housing of the UAV main body 20.

The antenna 82 may be used as an antenna of the RTK 80. The antenna 82 may be a hollow antenna. The antenna 82 may be a coil-shaped antenna. The antenna 82 may be spirally arranged along the side surface of the inner side of the housing 502. In one embodiment, the antenna 82 functions substantially the same as the RTK 80.

The antenna 82 may receive position information from a base station and a GPS satellite arranged at predetermined positions, respectively. In order to arrange the illuminance sensor 500 in a space with no obstacles around, it may be considered to arrange the illuminance sensor 500 on the top of the housing 502. However, when the illuminance sensor 500 is arranged on the top of the housing 502, the electromagnetic noise generated by the illuminance sensor 500 may interfere with the signal received by the antenna 82.

Therefore, in one embodiment, the illuminance sensor 500 is arranged in the cavity of the antenna 82. This may prevent electromagnetic noise generated by the illuminance sensor 500 from interfering with the signal received by the antenna 82.

The housing 502 may include a light-transmitting portion. The light-transmitting portion may include a first diffusion plate 510 that diffuses light from outside of the housing 502. The light receiving elements 504 may be used as the light-receiving part of the illuminance sensor 500. The light receiving elements 504 may receive light and convert the received light into electrical signals. The illuminance sensor 500 may measure the illuminance based on the electrical signals output from the light receiving elements 504. Each of the plurality of light receiving elements 504 may receive light in a different range of wavelengths. The first light receiving element among the plurality of light receiving elements 504 may receive light of a wavelength in the range of 400 nm or more and 700 nm or less. The second light receiving element among the plurality of light receiving elements 504 may receive light of a wavelength in the range of 700 nm or more and 900 nm or less. The third light receiving element among the plurality of light receiving elements 504 may receive light of a wavelength in the range of 900 nm or more and 1500 nm or less. In one embodiment, the light receiving elements 504 function substantially the same as the illuminance sensor 500 and are arranged in the cavity of the antenna 82.

The light guide members 520 may guide the light transmitted through the first diffusion plate 510 to the light receiving elements 504. The second diffusion plate 512 is arranged between the light guide members 520 and the light receiving elements 504 and diffuses the light from the light guide members 520. The light guide member 520 may have a rod shape. The light guide members 520 may be arranged in a direction from the top to bottom of the housing 502. The light guide members 520 may be arranged to stand on the base 501.

The first diffusion plate 510, the second diffusion plates 512, and the light guide members 520 may be made of resin, such as polycarbonate, polystyrene, Teflon®, acrylic, etc.

The antenna 82 may be arranged so as to surround the light guide members 520. The light guide members 520 may be arranged in the cavity of the antenna 82. By arranging the antenna 82 on the outside of the light guide members 520, it is possible to receive signals without being affected by electromagnetic noise of the illuminance sensor 500.

In one embodiment, the antenna 82 is a coil-shaped antenna. However, the antenna 82 may be composed of, for example, a plurality of rod antennas, and the plurality of rod antennas may be arranged around the periphery of the plurality of light guide members 520.

The rod cover 522 may be a hollow cover covering the outer surface of the light guide member 520. The outer side surface of the light guide member 520 and the inner side surface of the rod cover 522 may be separated. The cylinder 524 may be a holding member that holds the plurality of rod covers 522 inside. The cylinder 524 may have a plurality of through holes 525 for accommodating a plurality of rod covers 522, respectively. The rod cover 522 may be made of resin. The rod cover 522 is preferably made of a white material. Therefore, the light guided to the light guide member 520 may be efficiently reflected by the rod cover 522 and travel inside the light guide member 520. In addition, the cylinder 524 may be made of resin. The cylinder 524 is preferably made of a black material. Thus, it is possible to prevent excess light from entering the light guide member 520 from the outside.

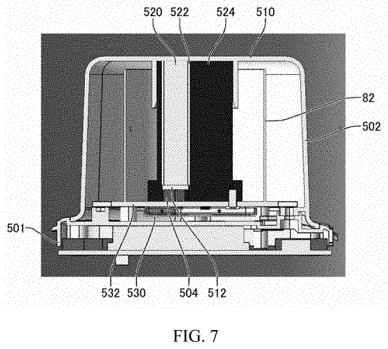

FIG. 7 shows a cross-sectional view of a sensor unit 600 according to one embodiment of the present disclosure. The sensor unit 600 may further include a substrate 530 on which the MCU 70 may be mounted and a substrate 532 which may be arranged on the substrate 530 and on which the antenna 82 and the light receiving elements 504 may be mounted.

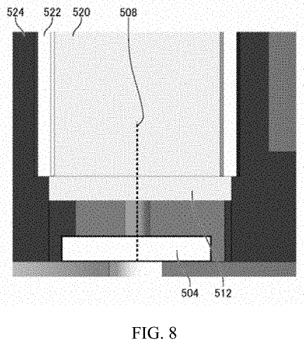

FIG. 8 is an enlarged cross-sectional view of the light receiving element 504 and the light guide member 520 according to one embodiment of the present disclosure. Referring to FIG. 8, the central axis of the light receiving surface of the light receiving element 504 and the central axis of the light guide member 520 are substantially aligned along the same straight line 508. As a result, the light receiving element 504 may efficiently receive the light guided by the light guide member 520.

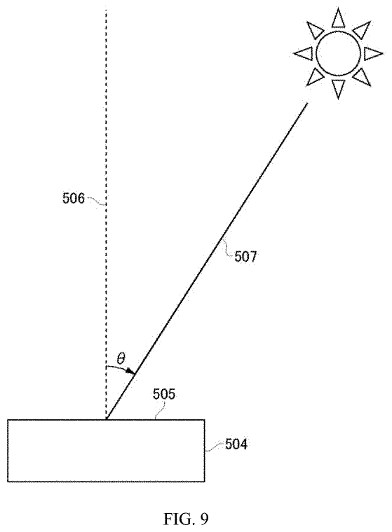

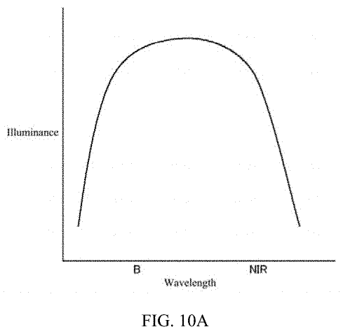

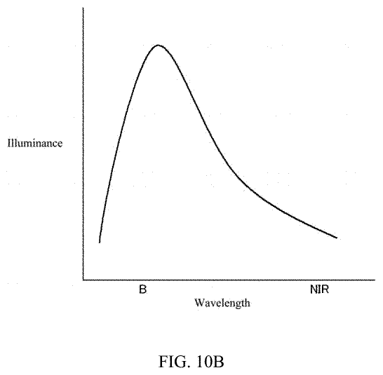

While the illuminance sensor 500 is used on a sunny day, the illuminance in the short wavelength region (e.g., blue, green) is larger than the illuminance in the long wavelength region (e.g., red) due to the Rayleigh scattering. However, when direct sunlight hits the illuminance sensor 500 perpendicularly, even when the illuminance sensor 500 is used on a sunny day, the influence of Rayleigh scattering may be ignored, and the illuminance difference between different wavelength regions is small. That is, according to the posture of the illuminance sensor 500, if the angle of sunlight irradiation changes, the illuminance of each wavelength region changes. For example, as shown in FIG. 9, when the incident angle θ changes, that is, when the angle of the direction 507 of sunlight incident with respect to the direction 506 perpendicular to the light receiving surface 505 of the light receiving element 504 changes, the illuminance of each wavelength measured by the illuminance sensor 500 changes. FIG. 10A shows the illuminance of each wavelength measured by the illuminance sensor 500 when the incident angle θ is 0 degree according to one embodiment of the present disclosure. FIG. 10B shows the illuminance of each wavelength measured by the illuminance sensor 500 when the incident angle θ is greater than 0 degree according to one embodiment of the present disclosure.

As shown in FIG. 10A, when direct sunlight hits the illuminance sensor 500 perpendicularly, the influence of Rayleigh scattering may be ignored, and the illuminance of each wavelength changes little. On the other hand, as shown in FIG. 10B, when sunlight does not directly or perpendicularly hit the light-receiving surface 505 of the light-receiving element 504, the illuminance in the short-wavelength range such as blue and green is greater than the illuminance in the long-wavelength range such as red under the condition of fine weather.

In one embodiment, even if the posture of the illuminance sensor 500 is changed, the illuminance ratio (spectral ratio) between each wavelength is preferably fixed. For example, even if the posture of the illuminance sensor 500 changes, the ratio VB/VNIR of the blue illuminance VB to the near-infrared illuminance VNIR is preferably fixed.

Therefore, in one embodiment, the first diffusion plate 510 is arranged on the incident surface side of the light guide member 520, and the second diffusion plate 512 is arranged on the exit surface side of the light guide member 520. As a result, even if the posture of the illuminance sensor 500 is changed, the illuminance ratio between each wavelength does not change.

In one embodiment, the first diffusion plate 510 may diffuse the short-wavelength light more than the long-wavelength light. Therefore, more short-wavelength light may be introduced into the light guide member 520 than the long-wavelength light. Therefore, even when direct sunlight hits the sensor unit 600, the illuminance in the short wavelength range such as blue and green is greater than the illuminance in the long wavelength range such as red.

In addition, the second diffusion plate 512 may diffuse the light traveling in the light guide member 520 and uniformly irradiates the light receiving surface of the light receiving element 504. Therefore, the light traveling inside the light guide member 520 may be efficiently received on the light receiving surface of the light receiving element 504.

In addition, by adjusting the light transmittance in the thickness direction of the first diffusion plate 510 based on the wavelength, it is possible to reduce the change of the illuminance ratio between each wavelength due to change of the incident angle θ. In one embodiment, the first transmittance, that is, the transmittance of the light in the first wavelength region including the blue wavelength region in the thickness direction of the first diffusion plate 510, may be smaller than the second transmittance, that is, the transmittance of the light in the second wavelength region including the red wavelength region in the thickness direction of the first diffusion plate 510. As such, the change of the illuminance ratio between each wavelength according to the incident angle θ is small. Among them, the second wavelength region is a longer wavelength region than the first wavelength region.

The difference between the first transmittance and the second transmittance of the first diffusion plate 510 may be greater than the difference between the third transmittance and the fourth transmittance of the second diffusion plate 512. Therefore, the change in the illuminance ratio between each wavelength is reduced. The third transmittance represents the transmittance of the light in the first wavelength region in the thickness direction of the second diffusion plate 512, and the fourth transmittance represents the transmittance of the light in the second wavelength region in the thickness direction of the second diffusion plate 512.

In addition, when the transmittance in the thickness direction of the diffusion plate is small, compared to when the transmittance in the thickness direction of the diffusion plate is large, light diffuses in directions other than the thickness direction. That is, when the transmittance in the thickness direction of the diffusion plate is small, the degree of light diffusion of the diffusion plate is greater than when the transmittance in the thickness direction of the diffusion plate is large.

Hereinafter, a plurality of diffusion plates having different transmittances in the thickness direction are respectively used for the first diffusion plate 510 and the second diffusion plate 512, and the experimental results will be explained after measuring the degree of deviation of the illuminance ratio corresponding to an incident angle θ.

The deviation of the illuminance ratio for each incident angle θ is measured based on the following equation:

$${X}_{G} ( {θ}_{n} ) = \frac{( {V}_{NIR} ( {θ}_{n} ) / {V}_{G} ( {θ}_{n} ) )}{\begin{matrix}( {V}_{NIR} ( {θ}_{1} ) / {V}_{G} ( {θ}_{1} ) + {V}_{NIR} ( {θ}_{2} ) / {V}_{G} ( {θ}_{2} ) + \\ … + {V}_{NIR} ( {θ}_{8} ) / {V}_{G} ( {θ}_{8} ) ) / 8\end{matrix}} \qquad Formula 2$$

X_{G} (θₙ) represents the deviation of the illuminance ratio of the green region G to the NIR region at certain incident angle θₙ. V_{NIR}(θₙ)/V_{G}(θₙ) represents the ratio of the illuminance in the green region G to the illuminance in the NIR region at an incident angle θₙ. ‘n’ represents a natural number. Here, the value of n ranges from 1 to 8.

The incident angle θ₁ represents 0 degrees, the incident angle θ₂ represents 10 degrees, the incident angle θ₃ represents 20 degrees, the incident angle θ₄ represents 30 degrees, the incident angle θ₅ represents 40 degrees, the incident angle θ₆ represents 50 degrees, the incident angle θ₇ represents 60 degrees, and the incident angle θ₈ represents 70 degrees.

V_{NIR}(θₙ)/V_{G}(θₙ) at each incident angle θₙ of 8 modes is measured and the difference between the maximum V_{NIR}(θₙ)/V_{G}(θₙ) and the minimum V_{NIR}(θₙ)/V_{G}(θₙ) is derived. Herein, this difference is defined as deviation amplitude (%). A small deviation amplitude (%) means that the deviation of the illuminance ratio due to the incident angles θ is small.

Here, the combination of the first diffusion plate 510 and the second diffusion plate 512 with a deviation amplitude (%) of 6% or less is “good”.

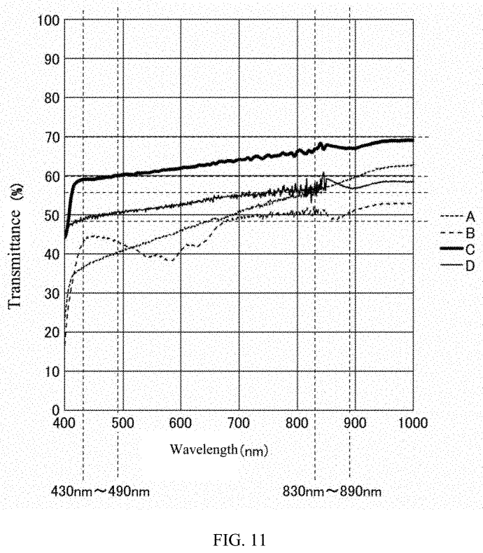

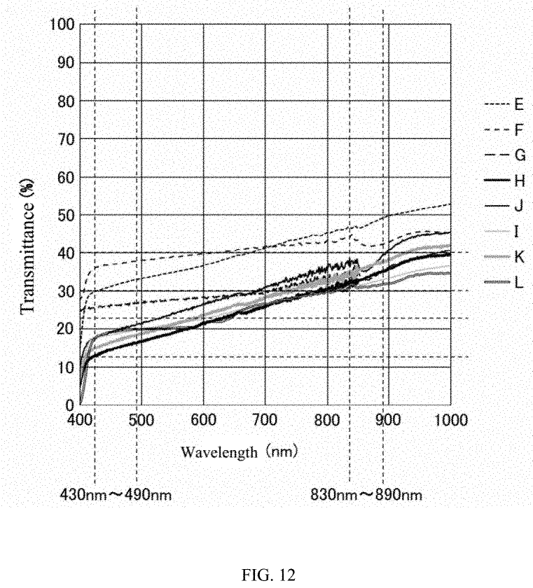

FIGS. 11 and 12 show the transmittance characteristics of the diffusion plates used for the first diffusion plate 510 and the second diffusion plate 512 for each wavelength. The deviation amplitude (%) of two diffusion plates which are selected from the diffusion plates A to L to be used for the first diffusion plate 510 and the second diffusion plate 512 respectively may be measured.

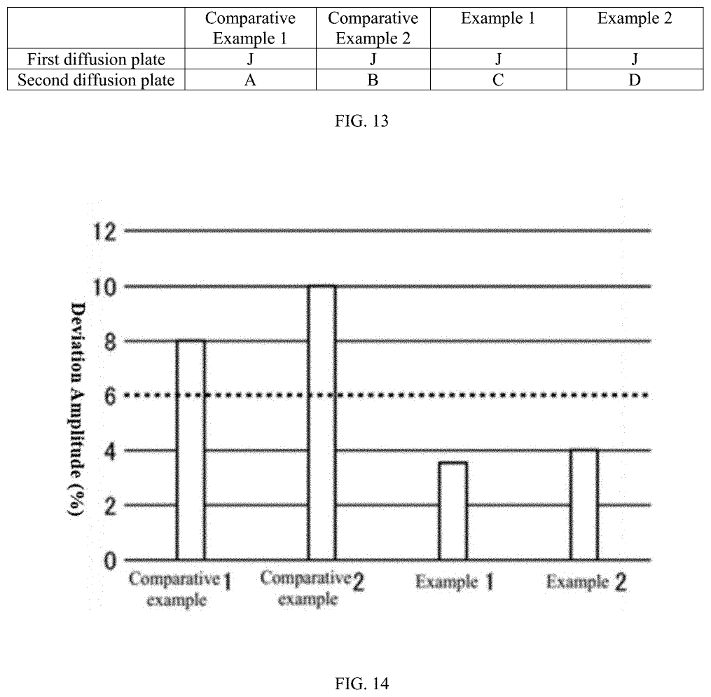

FIG. 13 shows different modes of combination of the first diffusion plate 510 and the second diffusion plate 512. FIG. 13 shows examples where the diffusion plate J was used as the first diffusion plate 510, and one of diffusion plates A, B, C, and D was used as the second diffusion plate 512.

FIG. 14 shows deviation amplitude (%) of each mode of the combination of the first diffusion plate 510 and the second diffusion plate 512 in FIG. 13.

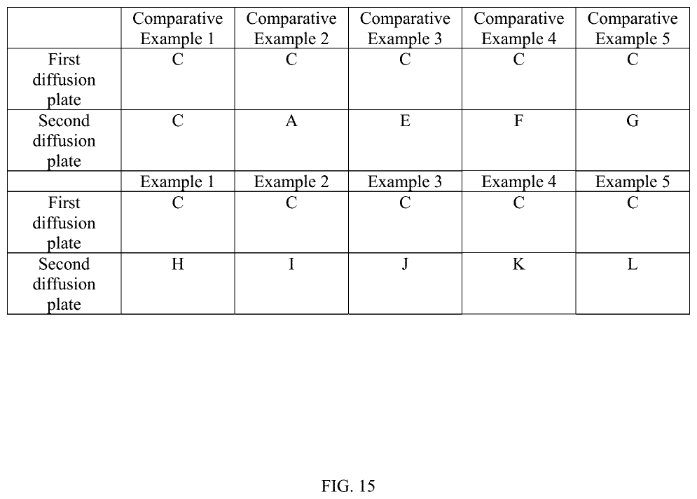

FIG. 15 shows different modes of combination of the first diffusion plate 510 and the second diffusion plate 512. FIG. 15 shows examples where the diffusion plate C was used as the first diffusion plate 510, and one of diffusion plates C, A, E, F, G, H, I, J, K, and L is used as the second diffusion plate 512.

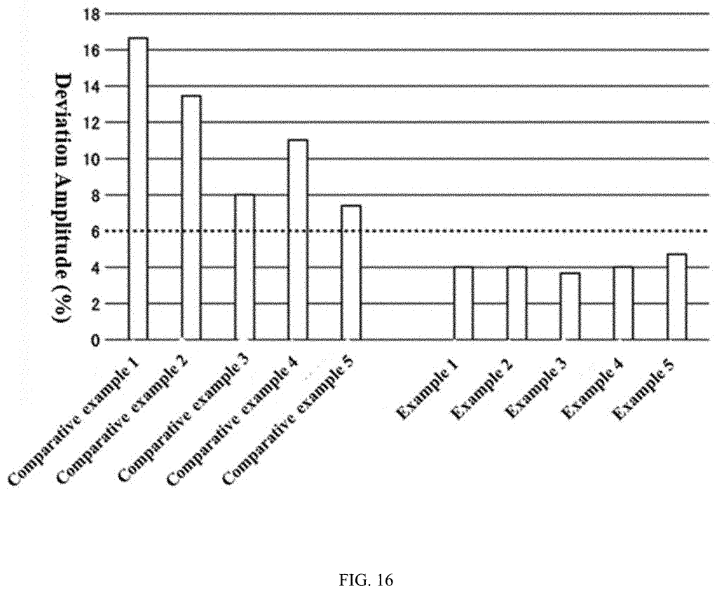

FIG. 16 shows deviation amplitude (%) of each mode of the combination of the first diffusion plate 510 and the second diffusion plate 512 in FIG. 15.

According to the results of these measurements, by using a diffusion plate having a transmittance of 30% or more and 40% or less for a light of a wavelength of 830 nm or more and 890 nm or less or a transmittance of 12% or more and 22% or less for a light of a wavelength of 430 nm or more and 490 nm or less as the first diffusion plate 510, a “good” result may be obtained.

Furthermore, by using a diffusion plate having a transmittance of 48% or more and 60% or less for a light of a wavelength of 830 nm or more and 890 nm or less or having a transmittance of 55% or more and 70% or less for a light of a wavelength of 430 nm or more and 490 nm or less as the second diffusion plate 510, a “good” result may be obtained.

The combinations of the first diffusion plate 510 and the second diffusion plate 512 may suppress the deviation of the illuminance ratio due to the incident angle θ by using the combination modes of the diffusion plates satisfying the above-mentioned conditions.

As described above, in the sensor unit 600 according to some embodiments of the present disclosure, the illuminance sensor 500 may be arranged in a limited space without reducing the measurement accuracy. In addition, it is possible to prevent electromagnetic noise generated by the illuminance sensor 500 from interfering with the signal received by the antenna 82 of the RTK 80 when the illuminance sensor 500 and the RTK 80 are arranged adjacent to each other in a limited space.

It should be noted that the execution order of the actions, sequences, steps, and stages in the devices, systems, programs, and methods shown in the claims, description, and drawings, as long as there is no special indication such as “before . . . ”, “in advance”, etc., and as long as the output of the previous processing is not used in the subsequent processing, they may be implemented in any order. Regarding the operation flow in the claims, the specification and the drawings, the description is made using “first,” “next,” etc. for convenience only, but it does not mean that it must be implemented in this order.

The present disclosure has been described above using the embodiments, but the technical scope of the present disclosure is not limited to the scope described in the above-mentioned embodiments. It is obvious to a person of ordinary skill in the art that various changes or improvements may be made to the above-mentioned embodiments. It is obvious from the description of the claims that all such changes or improvements may be included in the technical scope of the present disclosure.

### SYMBOL DESCRIPTION

10 UAV; 20 UAV Main Body 20; 30 UAV Control Unit; 32 Memory; 36 Communication Interface; 40 Propulsion Unit; 41 GPS Receiver; 42 Inertial Measurement Unit; 43 Magnetic Compass; 44 Barometric Altimeter; 45 Temperature Sensor; 46 Humidity Sensor; 50 Universal Joint; 60 Imaging Device; 82 Antenna; 100 Imaging System; 110 R Imaging Device; 120 G Imaging Device; 130 B Imaging Device; 140 RE Imaging Device; 150 NIR Imaging Device; 160 RGB Imaging Device; 300 Remote Operation Device; 500 Illuminance Sensor; 501 Base; 502 housing; 504 Light Receiving Element; 510 First Diffusion Plate; 512 Second Diffusion Plate; 520 Light Guide member; 522 Rod cover; 524 Cylinder; 525 Through Hole; 530 Substrate; 532 Substrate; 600 Sensor Unit

What is claimed is:

1. A mobile object, comprising:
a housing having a light-transmitting portion;
a light guide member inside the housing; and
a light receiving element inside the housing,
wherein the light guide member is configured to guide light transmitted through the light-transmitting portion to the light receiving element.

2. The mobile object of claim 1, wherein the light-transmitting portion comprises a first diffusion plate, and the first diffusion plate is configured to diffuse light from outside the housing.

3. The mobile object of claim 2, further comprising a second diffusion plate between the light guide member and the light receiving element, wherein the second diffusion plate is configured to diffuse light from the light guide member.

4. The mobile object of claim 3, wherein a first transmittance of the first diffusion plate is smaller than a second transmittance of the first diffusion plate, the first transmittance is a transmittance of light in a first wavelength region in a thickness direction of the first diffusion plate, the second transmittance is a transmittance of light in a second wavelength region in the thickness direction of the first diffusion plate, and a wavelength of the light in the second wavelength region is longer than that of the light in the first wavelength region.

5. The mobile object of claim 4, wherein the first wavelength region includes a blue light region, and the second wavelength region includes a red light region.

6. The mobile object of claim 4, wherein a difference between the first transmittance and the second transmittance of the first diffusion plate is larger than a difference between a third transmittance and a fourth transmittance of the second diffusion plate, the third transmittance is a transmittance of the light in the first wavelength region in a thickness direction of the second diffusion plate, and the fourth transmittance is a transmittance of the light in the second wavelength region in the thickness direction of the second diffusion plate.

7. The mobile object of claim 1, further comprising:
an antenna inside the housing,
wherein the antenna is configured to be arranged in a manner surrounding the light guide member.

8. The mobile object of claim 7, wherein the antenna is a hollow antenna and the light guide member is arranged in a cavity of the antenna.

9. The mobile object of claim 8, wherein the antenna is in a shape of a coil.

10. The mobile object of claim 7, further comprising a circuitry,
wherein the circuitry is configured to measure a position of the mobile object based on signals received by the antenna.

11. The mobile object of claim 1, further comprising:
a hollow cover covering an outer surface of the light guide member;
wherein an outer side surface of the light guide member is configured to be separated from an inner side surface of the hollow cover.

12. The mobile object of claim 11, comprising:
a plurality of light receiving elements;
a plurality of light guide members;
a plurality of hollow covers, and
a holding member inside the housing,
wherein the holding member is configured to hold the plurality of hollow covers inside the housing.

13. The mobile object of claim 12, wherein the hollow covers are configured to be in white, and the holding member is configured to be in black.

14. The mobile object of claim 13, wherein the holding member comprises a plurality of through holes configured to accommodate the plurality of hollow covers, respectively.

15. The mobile object of claim 1, wherein the light-transmitting portion of the housing is configured to be on a top of the mobile object.

16. The mobile object of claim 1, wherein the light guide member is rod-shaped, and a central axis of a light receiving surface of the light receiving element and a central axis of the light guide member are on a same straight line.

17. A sensor unit, comprising:
a housing with a light-transmitting portion;
a light receiving element inside the housing;
a light guide member inside the housing; and
an antenna inside the housing,
wherein the light guide member is configured to guide light transmitted through the light-transmitting portion to the light receiving element, and the antenna is configured to surround the light guide member.

18. The sensor unit of claim 17, wherein the light-transmitting portion comprises a first diffusion plate, and the first diffusion plate is configured to diffuse light from outside the housing.

19. The sensor unit of claim 18, further comprising:
a second diffusion plate between the light guide member and the light receiving element,
wherein the second diffusion plate is configured to diffuse light from the light guide member.

20. A sensor unit, comprising:
a housing comprising a first diffusion plate configured to diffuse and transmit light from outside the housing;
a light receiving element inside the housing;
a light guide member inside the housing; and
a second diffusion plate between the light guide member and the light receiving element,
wherein the light guide member is configured to guide the light transmitted through the first diffusion plate to the light receiving element and the second diffusion plate is configured to diffuse light from the light guide member.
